(19) United States
(12) Patent Application Publication
(10) Pub. No.: US 2010/0326219 A1
(43) Pub. Date: Dec. 30, 2010

(54) Band Clamp With Embedded Electronics

(75) Inventors: Daniel J. Nelson, Edgewater, CO (US); Brian Swetlic, Arvada, CO (US); Steve Franklin, Loughborough Leicestershire (GB); Andrew T. Ford, South Yorkshire (GB)

Correspondence Address: SHERIDAN ROSS PC, 1560 BROADWAY, SUITE 1200, DENVER, CO, 80202, US

(73) Assignee: Band-It-IDEX, Inc., Denver, CO (US)

(21) Appl. No.: 12/778,724

(22) Filed: May 12, 2010

Related U.S. Application Data
(60) Provisional application No. 61/177,369, filed on May 12, 2009.

(51) Int. Cl. G01M 19/00; B65D 63/00

(52) U.S. Cl. 73/865.8; 24/16 R

(57) ABSTRACT

A band and buckle for wrapping around and/or securing one or more objects is provided. Specifically, the band is adapted to receive external objects and maintain the received external objects within the band. The external objects may include electronic devices, sensors, Radio Frequency Identification (RFID) devices or other similar objects. These objects may be used for identifying the objects that are secured by the band, determining information about the band or its surrounding, and other various functions.

This application claims the benefit of U.S. Provisional Patent Application Ser. No. 61/177,369, filed May 12, 2009, the entire disclosure of which is incorporated by reference herein.

### FIELD OF THE INVENTION

Embodiments of the present invention are directed generally to a band, buckle, seal, tag, clamp, tie, fitting and associated devices, collectively referred to as “band clamp” for wrapping about and securing various objects. Specifically, the band clamp of one embodiment is configured to accommodate identification and/or sensing devices related to the band clamp and/or the objects to which the band clamp is associated.

### BACKGROUND OF THE INVENTION

Band clamps are used for bundling or securing objects together and typically comprise an elongated band having a free end and an end associated with a buckle. In operation, the band is wrapped around an object or group of objects and the free end is passed through the buckle and secured thereto to constrain the objects. A tool is used to tighten the band around the objects to secure or lock the free end of the band within a buckle or locking member by grasping the free end of the band after it has passed through the buckle. The tool simultaneously maintains the position of the buckle as the band is tightened around the group of objects. Once an appropriate tension is applied to the band, the tool creates a desired locking geometry in the band and/or buckle and shears the excess portion of the free end of the band that extends through the buckle.

In certain cases, band clamps are also used to identify the objects (e.g., cable, wire, tubing, pipes, etc.) around which they are secured. For example, very complex computer systems sometimes possess thousands of cables connecting hundred of various network nodes. Band clamps can be used to bundle wires in order to maintain an organized workspace. Once banded together, however, there may be no easy way to quickly ascertain what wires lead to what machines, for example.

Other situations also require various banded objects to be identified. For example, oilrigs employ hundreds of pipes that are marked so that workers can identify the pipe(s) and thus what type of materials are passed through the pipe(s). Over the course of several years, the markings or paint that identified each pipe may be worn away or covered up with dirt and debris, thereby affecting identification of the pipe.

There do exist some alternatives to simply painting on a pipe or writing on a bundle of wires for identification purposes. Examples of such solutions can be seen in FIGS. 1a-1c. The band clamps 2 of the prior art employed identification devices 6 comprised of stainless steel tags connected to the bands 2. Information relating to the band 2 or the objects 10 fastened by the band 2 are printed or embossed on the tags 6. Additionally, some products exist that use easy to read characters 8 attached to the tag. Even though the tags 6 provide an alternative to marking directly on the fastened object 10, the tags 6 can be obscured by dirt and debris, just like the pipe or wires they secure, thereby making it difficult, if not impossible, to identify the band or fastened object without cleaning the tag 6. Also, if the band 2 is placed in a dark area it may be difficult to even read the tag 6. Therefore, a need exists for a band clamp or tag that can be inspected in dirty and low light conditions.

Another problem that currently exists is retention forces in bands may change as they age. A tag is also susceptible to being dislodged or falling off over time, particularly if it is located in an environment subjected to varying conditions, such as extreme weather fluctuations. Furthermore, band clamps that are used to secure pipes and are open to the elements tend to wear as time passes. Outside of physical inspection, there is no way for anyone to know the condition of the band clamp. It is also very difficult to know when exactly to replace and/or adjust a band clamp. Approximations can be used to determine about when a band clamp should be replaced, but these approximations are approximations based upon visual inspections of the band clamp. Thus, a band is needed that does not require visual inspection in order to determine information about the band and/or objects secured by the band.

### SUMMARY OF THE INVENTION

In one embodiment of the present invention, a band clamp is provided that is adapted to receive an electronic device. The electronic device contains information or refers to information related to the band clamp, objects secured by the band clamp, and/or conditions of and around the band clamp. The electronic device may communicate with external devices to relay information about the band clamp. In accordance with at least some embodiments of the present invention, the electronic device may include an RFID chip, pressure sensor, strain gage or other load sensing device, temperature sensor, accelerometer, or other type of sensor that can determine information about the band and its surroundings. The band may also be configured to receive a second electronic device that can respond to information from the first electronic device. For example, a piezoelectric device may be embedded along with a sensing device in order to create a reactive band. The first electronic device (i.e., a strain gage) may detect changes in the load on the band and relay that information to the second electronic device. The second electronic device (i.e., a piezoelectric device) may expand or contract to maintain a constant load in the band clamp. The electronic device may be an accelerometer that senses vibrations in the object secured by the band. Based upon readings recovered from the accelerometer, the piezoelectric material responds to the sensed vibrations and actively dampens vibrations in the system by contracting and expanding the band clamp accordingly.

In accordance with at least some embodiments of the present invention, the electronic device may be (or include) a Radio Frequency Identification integrated circuit or chip (RFID) that stores or refers to identification information about the band, objects secured by the band and the environment in which the band is located. The RFID electronic device includes a processor, memory, and transmitter/receiver unit. An RFID scanner passed within proximity of the band may interrogate the RFID and retrieve information about the band clamp (i.e., identification information, stress and strain data, external weather conditions information, and the like) from the memory of the electronic device. Instead of visually inspecting a band, the objects or environment around the band clamps, a user can determine information about that band clamp and/or object by simply passing an RFID scanner close to the band with the embedded electronic device.

In accordance with at least one embodiments of the present invention, the band clamp can be configured in a number of ways to receive an electronic device. In one embodiment, the band clamp may have a recess, receptor or deformation (e.g., bevel, cut, stamping or other type of geometry) that would allow an electronic device to be placed within, on or around the band clamp. Additionally, the band clamp may have restraints on the surface, or in the recess, that can receive and hold the electronic device in place. Still further, the band clamp may have a pocket located on one side that allows the electronic device to be placed in the pocket. The electronic device may be further held in place by adhesives or the like, although adhesives are not required, or by a combination of adhesives and friction fit. As can be appreciated by one of skill in the art, adhesives may or may not be the only securing mechanism employed in order to fasten the electronic device to the band clamp. Adhesive materials or potting materials may also function to protect the electronic device from shock and adverse environment such as moisture.

Additionally, a band clamp may be equipped with electronic equipment including long-range information transmission apparatus and a local power supply. The transmission apparatus may be operable to transmit information from the memory of an electronic device to a monitoring agency. Thus, conditions about the band clamp, the actual state of the band clamp, and/or the surrounding environment may be retrieved without requiring a person to physically travel to and inspect the band clamp or the contents surrounded by the band.

A band clamp is provided that is adapted to be secured about an object, comprising: a first end; a second end that is adapted to interface with the first end to substantially inhibit relative movement of the first and second ends; a first band portion between the first end and the second end having a top surface and a bottom surface that are substantially parallel to one another, the first band portion comprising a recess or receptor in at least one of the top and bottom surface, wherein the recess is adapted to receive an external object and maintain the external object in proximity to the first band portion, and wherein the external object comprises a sensor that is operable to determine information related to at least one of the band and the surroundings of the band.

A band clamp adapted to be secured about an object is provided, comprising: a first end; a second end that is adapted to interface with the first end to substantially inhibit relative movement of the first and second ends; a portion between the first end and the second end having an inside surface and an outside surface, wherein the portion comprises a means for receiving an external object in at least one of the top and bottom surface.

A band clamp adapted to be secured about an object is provided comprising a first end; a second end that is adapted to interface with the first end to substantially inhibit relative movement of the first and second ends; a portion between the first end and the second end having an inside surface and an outside surface, wherein the portion interfaces with a sensor that is operable to determine information related to at least one of the band and the surroundings of the band.

A method of sensing change in conditions of bundled objects is provided, comprising: wrapping a band comprising a sensor about at least one object; and sensing a change in the conditions of and/or about the at least one object, wherein the change in the conditions comprises at least one of a change in position, an increase or decrease in strain of the band, a change in diameter of the band, and change in environmental conditions about the band.

The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

FIG. 1a depicts a band identification technique of the prior art;

FIG. 1b depicts an alternative band identification technique of the prior art;

FIG. 1c depicts an alternative band identification technique of the prior art;

FIG. 2 is a top view of a band clamp capable of receiving an electronic device in accordance with embodiments of the present invention;

FIG. 3 is a cross sectional elevation view of a band having a recessed portion to receive an electronic device in accordance with embodiments of the present invention;

FIG. 4 is a cross sectional elevation view of a band having an alternative configuration of the recessed portion in accordance with embodiments of the present invention;

FIG. 5 is a cross sectional elevation view of a band having an alternative configuration of the recessed portion in accordance with embodiments of the present invention;

FIG. 6 is a cross sectional elevation view of a band having a pocket adapted to receive an electronic device in accordance with embodiments of the present invention;

FIG. 7 is a plan of a band adapted to receive an electronic device in accordance with embodiments of the present invention;

FIG. 8 is a cross sectional elevation view of a band adapted to receive an electronic device in accordance with embodiments of the present invention; and

FIG. 9 is a plan view of a band with a tag, punch or clip attached to the band with an associated electronic device.

FIG. 10 is a perspective view of an alternative embodiment of a band clamp stamped to form a receptacle or pocket for receiving an electronic device and further showing at least one opening to allow reception and transmission of RFID signals.

FIG. 11 is an elevation view of the band clamp of FIG. 10.

FIG. 12 is a perspective view of an alternative embodiment of a band clamp stamped to form a pocket for receiving an electronic device and further showing an opening to allow reception and transmission of RFID signals.

FIG. 13 is a side elevation view of the band clamp of FIG. 12.

FIG. 14 is a perspective view of the opposite sides of the band clamps shown in FIGS. 10 and 12, further showing an electronic device positioned in the pocket.

FIG. 15 is a perspective view of an alternative embodiment of a band clamp that possesses a pocket for receiving an electronic device.

FIG. 16 is a perspective view of the opposite side of the band clamp of FIG. 15 showing an electronic device positioned in the pocket.

FIG. 17 is a perspective view of an alternative embodiment of a band clamp that possesses a pocket for receiving an electronic device.

FIG. 18 is a perspective view of the opposite side of the band clamp of FIG. 17 showing an electronic device positioned in the pocket.

FIG. 19 is a block diagram depicting one type of electronic device that can be used in conjunction with embodiments of the present invention.

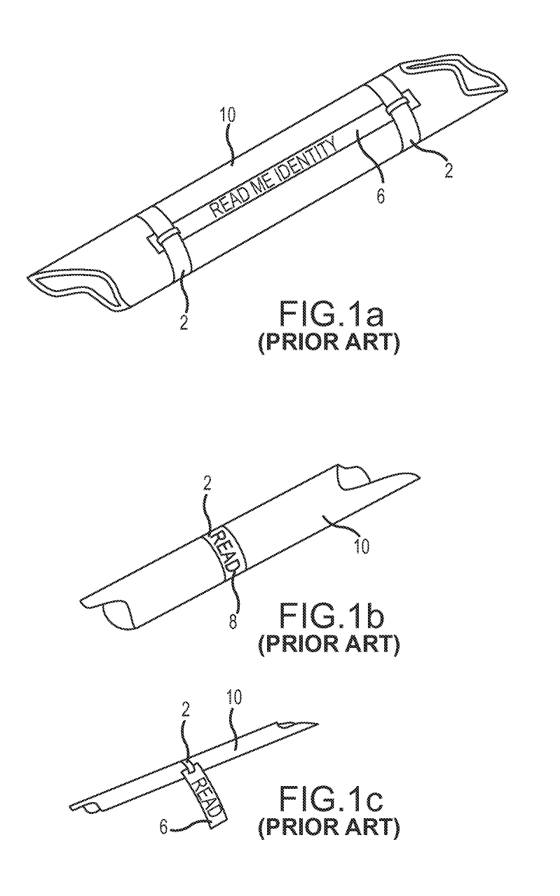

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

Embodiments of the present invention are generally related to band clamps 2 used to fasten various objects together or wrap around a single object like a pipe 10, a collection of pipes, wire, a collection of wires, hoses, and the like. The band clamp 2 accommodates additional electronics that can be used for a number of functions relating to both the band clamp 2 and the objects around which the band is associated.

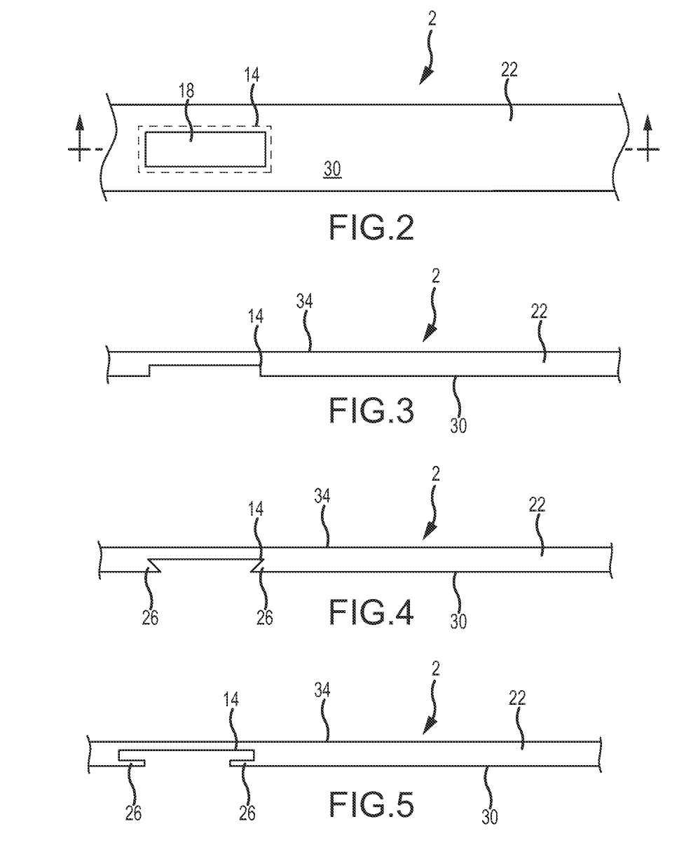

Referring to FIGS. 2-4, one embodiment of a band 2 is shown that possesses a recessed cavity 14 that is configured to receive an electronic device 18. The recessed cavity 14 is countersunk relative to the band 22. The recessed cavity 14 is formed in from the parent metal of the band in order to provide a location for receiving the electronic device 18 to maintain a smooth surface across the length of the band 22. As can be appreciated by one of skill in the art, the band may be supplied in a flat state or in a pre-formed state. For example, the band 22 may be a Tie-Lok®, Ultra-Lok®, Jr® Band-Fast, or other band clamp. The configuration of the band 22 allows electronics 18 for use in sensing, identification, and other applications to be embedded in or directly mounted to the band 22.

As shown in FIGS. 4 and 5, the configuration of the cavity 14 may employ retaining edges 26. The retaining edges 26 might be fabricated of a softer, more ductile material that allows the selective insertion or retrieval of an electronic device. The retaining edges 26 help to ensure that an electronic device is substantially fixed once it is placed inside the cavity 14. The retaining edges 26 can be used to make sure the electronic device does not dislodge. Additionally, the electronic device may be secured in the cavity 14 with an adhesive or by placing another layer of material over the top of the cavity 14 once the electronic device is secured in place. As noted above, a cavity 14 may not be necessary to secure the electronic device to the band 22. More specifically, in accordance with at least some embodiments of the present invention, the electronic device may be secured to the band 22 solely by an adhesive, tape or the like or by a component placed on the device and secured to the band.

The retaining edges 26 may be separate tabs or integral portions of the band 22 and do not need to completely conform the cavity 14 to any particular electronic device. The retaining edges may be configured to allow various electronic devices of different sizes into and out of the cavity 14 of the band 22. In an alternative configuration, the band 22 may only have one retaining edge instead of multiple retaining edges shown. Various combinations and uses of the retaining edges 26, with or without a cavity 14, are possible for use in an electronic device 18. The retaining edges may alternatively be latches, deformable tabs, lips, fingers etc. that selectively open to allow the placement and removal of an electronic device into the cavity 14.

In accordance with embodiments of the present invention, the cavity 14 may be integrated into an inner side 30 or an outer side 34 of the band 22. For example, if the cavity 14 is integrated on the inner side 30 of the band 22, the electronic device will be closer to the object around which the band 22 is secured. However, if the cavity 14 is located on the outer side 34 of the band 22, then the electronic device would reside farther away from the objects that are secured by the band 22. In certain instances it may be advantageous to have the electronic device closer to, or even in contact with, the object secured by the band 22, especially when the electronic device includes sensors that determine information about the objects secured by the band 22. In an alternative configuration, the electronic device may be preferably on the outer side 34 of the band 22 in order to allow easier access of the electronic device. This may be advantageous if the electronic device needs to be replaced, repaired, or interrogated at any point during its use.

Referring now to FIG. 6, the use of a pocket 38 to hold an electronic device rather than a cavity is shown. The pocket 38 may be an appendage 42 attached to or incorporated to the band 22. The pocket 38 may be placed either on the inner side 30 and/or the outer side 34 of the band 22. As can be appreciated, if the pocket 38 is not flush with the surface of the band 22, it might be preferable to have the pocket 38 on the outer side 34 of the band 22 so that the secured electronic devices held inside are not damaged when the band 22 is tightened. The pocket 38 facilitates insertion and removal of electronic devices. The pocket 38 and appendage 42 may be used in conjunction with a cavity described above to create a recessed pocket. If a recessed pocket is employed, the appendage 42 would generally lie in the same plane as the inner side 30 or outer side 34 of the band 22. The appendage 42 may hingedly interconnected to the band 22 to function as a selectively openable door to conceal the electronic device. As can be appreciated by one of skill in the art, the appendage 42 along with the retaining portions 26 may be made of any type of material including the material of the band 22. For instance, the retaining portions 26 and the appendage 42 may be made of stainless steel, aluminum or other types of metal, plastic, nylon, rubber, elastomers and the like.

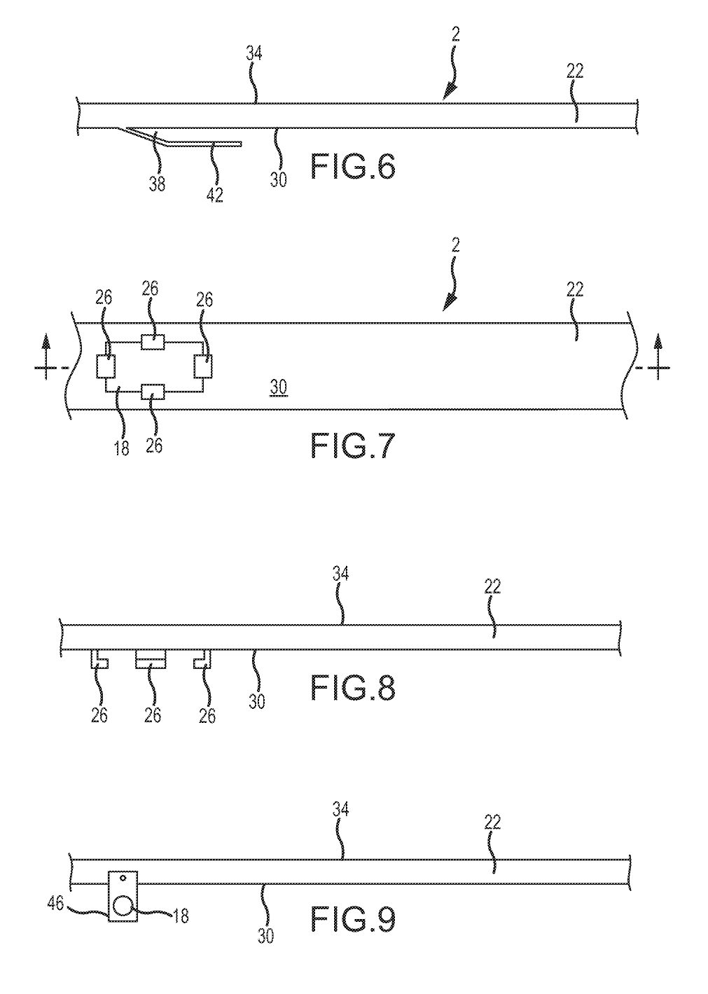

Referring now to FIGS. 7 and 8, a band clamp 2 having one or more retaining elements 26 is provided. The retaining elements 26 may be located on the inner side 30 and/or the outer side 34 of the band 22. Using the retaining elements 26 shown may be useful if the band 22 is thin wherein the cavity described above would affect the structural integrity of the band 22. The retaining elements 26 are adapted to receive the electronic device and hold it in place and may be used to selectively receive electronic device 18. Although four retaining elements 26 depicted in FIG. 7, one of ordinary skill in the art can appreciate any number of retaining elements 26 may be provided without departing from the scope of the invention.

Referring again to FIGS. 2 through 8, a method of manufacturing one embodiment of the present invention is shown and described. More specifically, one skilled in the art will appreciate that the band 22 and elements mounted thereon or integral thereto may be constructed of a rigid and/or a compliant material depending upon the desires of the end user. Compliant materials such as leather, rubber, nylon, alone or in combination with selectively placed members or rigidity may be employed. Rigid materials such as plastics, forged steels, composites, and the like, may also be employed either alone or in combination with the previously described compliant materials.

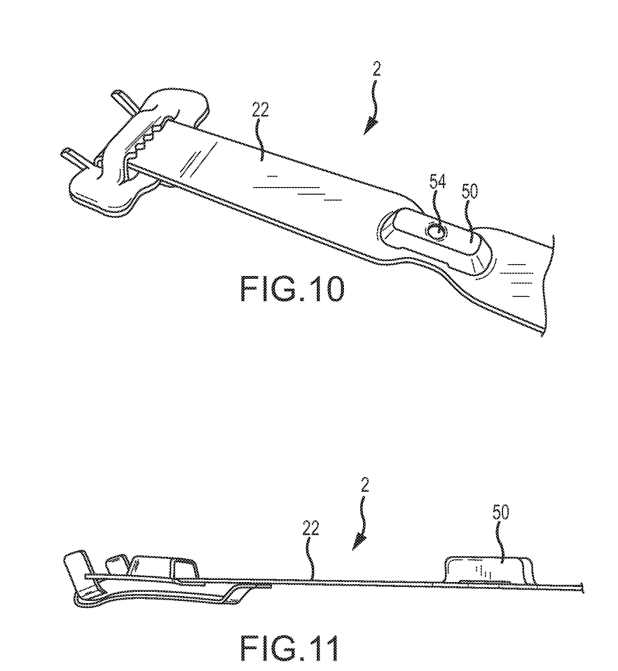

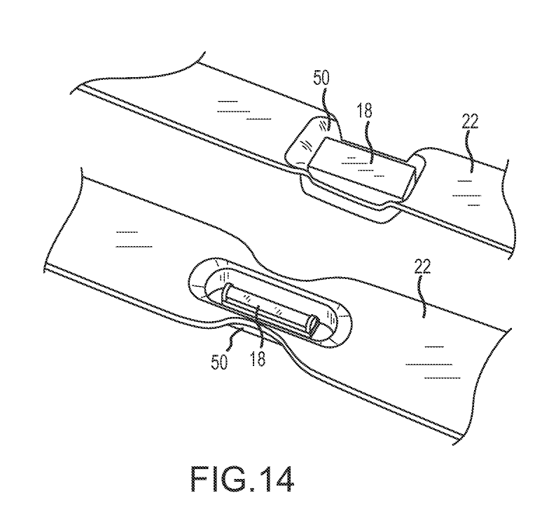

A band 22 with an attached tag, punch or clip 46 is shown in FIG. 10. The electronic device 18 is attached to the tag 46 by adhesives or by utilizing one of the attachment methods described in association with the embodiments above. Further still, a recess may be formed by stamping the tag 46, the electronic device 18 placed within the stamped portion. Examples of stamped portions are discussed below in connection with FIGS. 10-18. The electronic device 18 may be secured in the recess defined by the stamped portion with adhesive or interference fit or a combination of both. The electronic device 18 may also be fully encapsulated in a potting material to protect it against shock and/or environmental conditions.

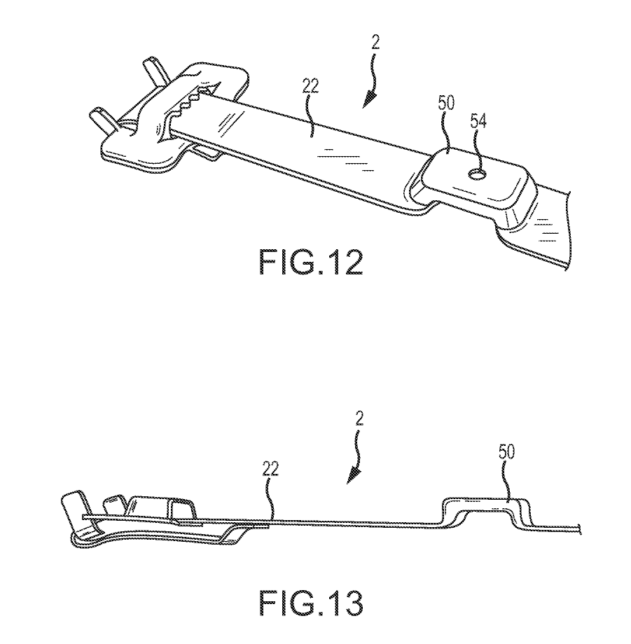

Referring now to FIG. 10, the band clamp 2 is shown with a deformed portion 50, which may be made by stamping that receives the electronic device 18. An aperture 54 may be optionally located in the base of the deformed portion 50 to facilitate transmission of radio waves to or from the electronic device 18. FIG. 12 shows an alternative embodiment of the deformed portion 50 that is designed to secure an electronic device 18 positioned within a deformed portion 50. It should be appreciated that the band 2 may be attached to one or more objects with the open side of the stamping facing away from the objects or positioned facing the objects being secured.

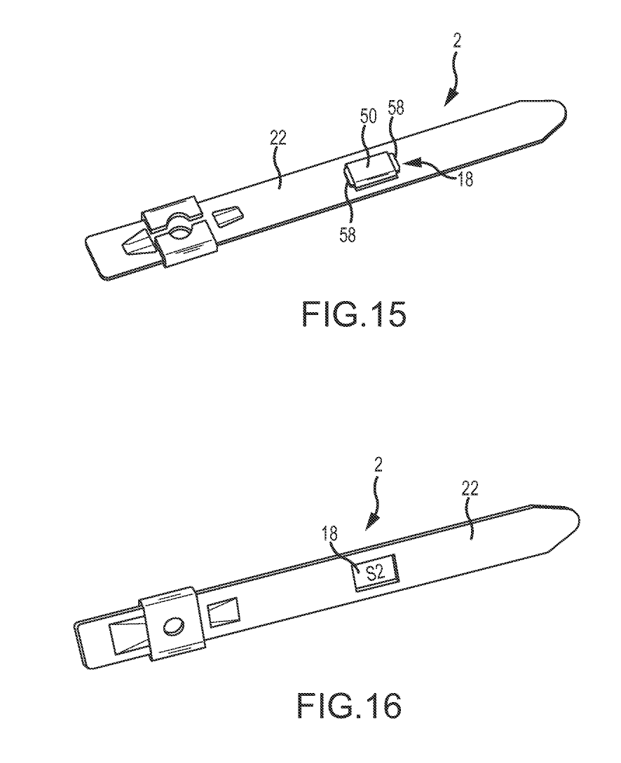

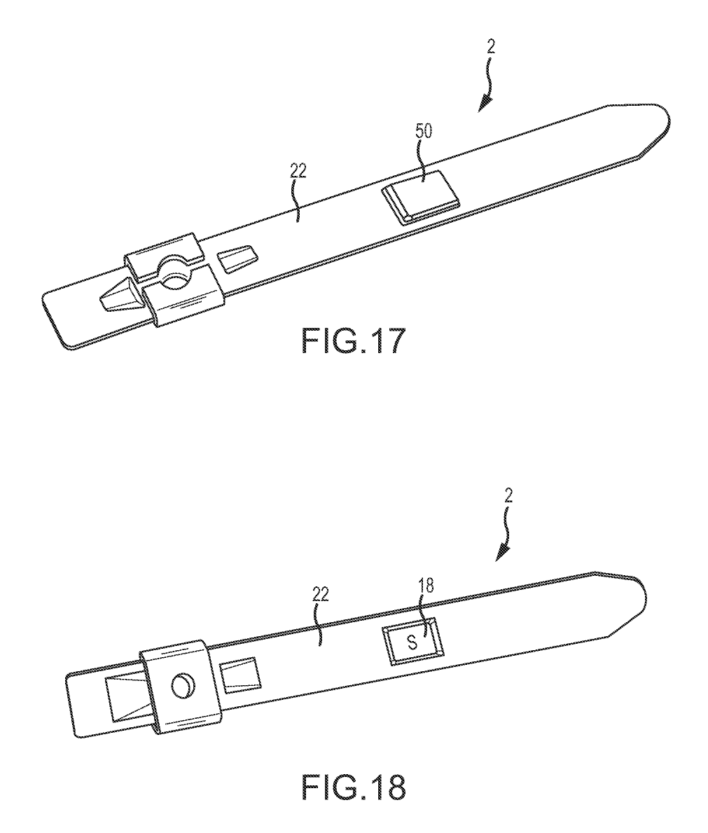

Referring now to FIGS. 15 and 16, still further alternative embodiments of the band 2 are shown. As shown in FIG. 15, the deformed portion 50 has openings 58 so that the electronic device 18 is visible. The opposite side of this band clamp 2 is shown in FIG. 16. The openings 58 permit transmission of radio waves. In comparison, in the stamping of FIGS. 17 and 18, no openings are formed in the deformed portion 50 and radio waves are accessible only through the opening visible on the opposed side of the band clamp 2 shown in FIG. 18.

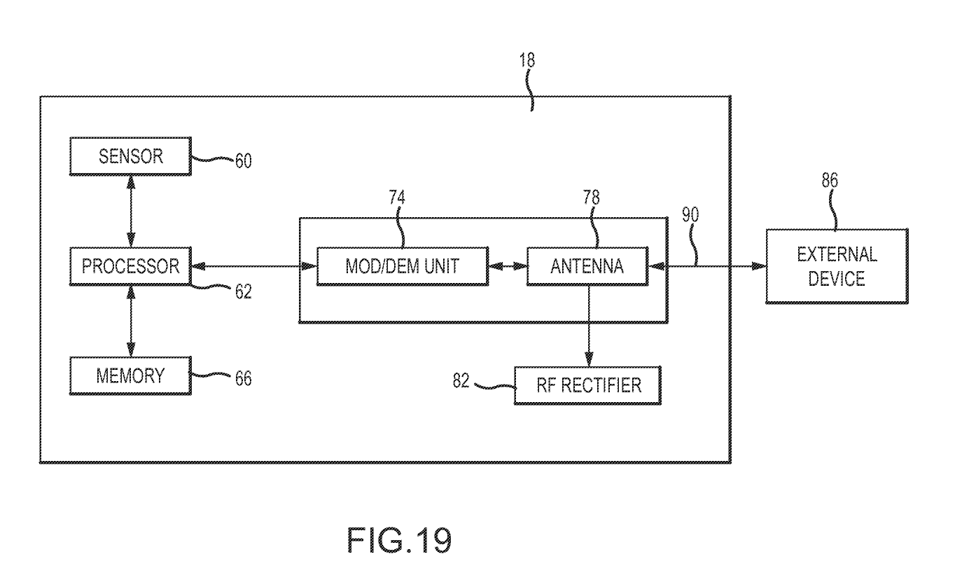

FIG. 19 shows an exemplary electronic device 18 that includes a sensor 60, a processor 62, a memory 66, a transmission and receiving unit 70 that includes a modulation\demodulation unit 74, an antenna 78, and an RF rectifier 82. The processor 62 may be any type of device that is capable of performing functions and supplying instructions to other components of the electronic device 18. The processor 62 may be, for example, an application specific integrated circuit (ASIC), microprocessor, programmable controller, or the like that uses bi-directional interfaces to communicate with various other parts of the electronic device 18.

The memory 66 of the electronic device 18 generally comprises at least one array of non-volatile memory cells, e.g., static random access memory (SRAM) cells or Flash Memory Cells, among other types of non-volatile memory cells. The memory 66 may also comprise at least one array of dynamic random access memory (DRAM) cells. Therefore a content of at least a portion of the memory 66 may be pre-programmed and write protected thereafter (read-only), whereas the content of other portions of the memory 66 may modified (read/write).

Various types of information are stored in memory 66. Executable functions to be performed by the processor 62 may be stored in the read-only portion of the memory 66. Information relating to the identity of the band and/or objects secured by the band may also be stored in either in the read-only or read/write portions of memory 66.

The electronic device 18 is enabled to communicate with external devices 86 via an interface. In accordance with embodiments of the present invention, the electronic device 18 may be an RFID that is used to identify the band and/or the objects secured by the band. The external device 86 used to communicate with the electronic device 18 may be, for example, an RF interrogator that is passed within proximity of the electronic device 18 in order to determine information about the band and/or the objects secured by the band.

In accordance with at least some embodiments of the present invention, the band may be equipped with a power supply and a broadcast member. The broadcast member may be able to transmit information about the band to entities a large distance away from the band. For example, the electronic device 18 within the band may include a cellular communication system that is programmed to transmit data from the memory 66 of the electronic device 18 to a control station that monitors the status of the band and the conditions around the band. Information that may be sent to such a monitoring station can include, but is not limited to, stress/strain information, weather information, identification information, and data showing whether the band has been tampered with. This way a technician will only need to go to the location of the band when information received at the monitoring station indicates that the band needs some sort of attention.

Once the external device 86 is close enough (e.g., RF signals transmitted from the RF interrogator can be received and deciphered by the electronic device 18 and RF signals transmitted from the electronic device 18 can be received and deciphered by the external device 86), a signal is received from the external device 86 by an interface 90 at the antenna 78. The antenna 78 sends a signal to the modulation\ demodulation unit 74 where it is demodulated and sent to the processor 62. The processor 62 then performs functions (stored in memory 66) based on the type of signal received. Typically, the external device 86 queries the electronic device 18 for identification information of the band and/or objects secured by the band. As noted above, this type of identification information is stored in the memory 66 of the electronic device 18. When the processor 62 receives the signal to identify the electronic device 18 and thus the band, that information is recovered from memory 66. The processor then sends a signal containing the requested information to the modulation\ demodulation unit 74. The signal is then modulated and sent to the antenna 78 to be communicated back to the external device 86 by interface 90.

In accordance with embodiments of the present invention, the electronic device 18 is not battery powered. Rather, it is passive and only becomes activated and powered when it receives interrogation signals from an external device 86 via interface 90. RF signals inherently contain energy and when the signals are received in antenna 78, they may be forwarded to the RF rectifier 82 where the energy is recovered from the signal to power the various elements of the electronic device 18. Alternatively, or in combination with the RF rectifier 82, the electronic device 18 may contain an additional power source like a battery (not shown).

In accordance with embodiments of the present invention, the sensor 60 may also be included in the electronic device 18. As can be appreciated by one of skill in the art, the sensor 60 may be integral to the electronic device 18 or may be a separate electronic device that is in communication with the first electronic device. The sensor 60 is used to detect information, specifically changes in the environment around and relating to the band. As noted above, the sensors 60 may be, for example, a pressure sensor, strain gauge, piezo electric element or other load sensing device, temperature sensor, accelerometer, or other type of sensor that determines information about the band and its surroundings.

Information detected at the sensor 60 is forwarded to the processor 62 which then can send the information to memory 66 for storage and subsequent recovery at a later date by an external device 86 and/or forward the signal onto the modulation\ demodulation unit 74. There information obtained from the sensor 60 is modulated into a signal suitable for transmission and that signal is forwarded to antenna 78, which then communicates modulated signal to the external device 86 via interface 90. The external device 86 may be an RFID interrogator as noted above. The interrogator may wish to recover information from the memory 66 that relates to the sensor 60. This may be useful to determine historical averages or changes in the temperature, loads, and other conditions related to the band 100 and/or objects secured by the band 100. In an alternative configuration, the sensor 60 is in direct communication with the external device 86 by a wired interface. This configuration allows the sensor 60 to communicate, without the use of the processor, with external devices. Furthermore, the sensor 60 may be a stand-alone sensor that is, by itself, the electronic device 18.

In accordance with alternative embodiments of the present invention, the external device 86 may be a piezoelectric device that can control the tension in the band 100. If the sensor 60 detects a sharp spike in tension or stress in the band, the information is relayed to the external device 86 (e.g., through direct or indirect connections) where the external device 86 can expand to relieve the tension in the band 100. The sensor 60 may also be an accelerometer that detects vibration in the object(s) that is secured by the band 100. The vibration information, again, is sent to the piezoelectric device where the piezoelectric device can contract or expand the band 100 in order to dampen the vibrations in the objects secured by the band 100. The additional piezoelectric device may be incorporated into the band 100 just as described with reference to FIGS. 2 through 8. As can be appreciated by one of skill in the art, a single band 22 may be configured to receive more than one electric device 18. For example, a cavity 14 may be created for a first electric device 18 (e.g., a sensor and/or identification unit) and a second cavity may exist on the band 22 where the second recess portion contains a second electronic device which is a piezoelectric or other type of reactive electric device 18.

The foregoing discussion of the invention has been presented for purposes of illustration and description. The foregoing is not intended to limit the invention to the form or forms disclosed herein. For example, while the illustrated embodiments show an electronic device attached to a band or a tag, it should be appreciated that the electronic device may also be attached to a buckle, seal, cable, tie, fitting or other structure associated with clamping or bundling objects. Also, while the foregoing description addressed methods for securing an electronic device to a band clamp, including a friction fit and/or adhesives, other methods known to those of skill in the art, including welding, are deemed within the scope of the present invention. Further still, it is contemplated that the electronic device may be affixed to a carrier and the carrier attached to the band clamp rather than affixing the electronic device directly to the band clamp. Additionally, in the foregoing detailed description, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed.

What is claimed is:

1. A band clamp adapted to be secured about an object, comprising:
a first end;
a second end that is adapted to interface with the first end to substantially inhibit relative movement of the first and second ends;
a first band portion between the first end and the second end having a top surface and a bottom surface that are substantially parallel to one another, the first band portion comprising a receptor in at least one of the top and bottom surface, wherein the receptor is adapted to receive an external object and maintain the external object in proximity to the first band portion, and wherein the external object comprises a sensor that is operable to determine information related to at least one of the band and the surroundings of the band.

2. The band clamp of claim 1, wherein the sensor comprises at least one of a temperature sensor, accelerometer, and strain gage.

3. The band clamp of claim 2, wherein the external sensor further comprises a piezoelectric device that is operable to receive information from the sensor and is further operable to use the received information to adjust a tension in the band.

4. The band clamp of claim 1, wherein the external object is a Radio Frequency Identification (RFID) device, and wherein the RFID device is capable of storing and presenting information related an object secured by the band.

5. The band clamp of claim 1, wherein the first band portion further comprises restraints for receiving and holding the external object in a substantially fixed location on the first band portion.

6. A band clamp adapted to be secured about an object, comprising:
a first end;
a second end that is adapted to interface with the first end to substantially inhibit relative movement of the first and second ends;
a portion between the first end and the second end having an inside surface and an outside surface, wherein the portion comprises a means for receiving an external object in at least one of the top and bottom surface.

7. The band clamp of claim 6, wherein the external object comprises a sensor that is operable to determine information related to at least one of the band and the surroundings of the band.

8. The band clamp of claim 7, wherein the sensor comprises at least one of a temperature sensor, accelerometer, and strain gage.

9. The band clamp of claim 8, wherein the sensor further comprises a piezoelectric device that is operable to receive information from the sensor and is further operable to use the received information to adjust a tension in the band.

10. The band clamp of claim 6, wherein the external object is a Radio Frequency Identification (RFID) device, and wherein the RFID device is capable of storing and presenting information related to an object secured by the band.

11. The band clamp of claim 6, wherein the means for receiving comprises restraints for holding the external object in a substantially fixed location on the portion.

12. The band clamp of claim 6, wherein the means for receiving maintains the external object substantially parallel to the surface in which the recessed portion resides.

13. The band clamp of claim 6, wherein the external object is a Radio Frequency Identification (RFID) device, and wherein the RFID device is capable of storing and presenting information related to an object secured by the band to a location physically separated from the band.

14. A band clamp adapted to be secured about an object, comprising:
a first end;
a second end that is adapted to interface with the first end to substantially inhibit relative movement of the first and second ends;
a portion between the first end and the second end having an inside surface and an outside surface, wherein the portion interfaces with a sensor that is operable to determine information related to at least one of the band and the surroundings of the band.

15. The band clamp of claim 14, wherein the portion comprises a recess adapted to receive the sensor in at least one of the top and bottom surface.

16. The band clamp of claim 14, wherein the sensor interfaces with the portion through an adhesive.

17. The band clamp of claim 14, wherein the sensor comprises at least one of a temperature sensor, accelerometer, and strain gage.

18. A method of sensing change in conditions of bundled objects, comprising:
wrapping a band comprising a sensor about at least one object; and
sensing a change in the conditions of and/or about the at least one object, wherein the change in the conditions comprises at least one of a change in position, an increase or decrease in strain of the band, a change in diameter of the band, and change in environmental conditions about the band.

19. The method of claim 18, further comprising storing information relating to the sensed change and transmitting the sensed change information.

20. The method of claim 18, wherein the sensor comprises at least one of a temperature sensor, accelerometer, and strain gage.
